(19) United States
(12) Patent Application Publication
(10) Pub. No.: US 2016/0120168 A1
(43) Pub. Date: May 5, 2016

(54) HUNTING SCENT RELEASING DEVICE

(71) Applicant: Roger Neal Blaha, Canton, MI (US)

(72) Inventor: Roger Neal Blaha, Canton, MI (US)

(21) Appl. No.: 14/794,477

(22) Filed: Jul. 8, 2015

Related U.S. Application Data
(60) Provisional application No. 62/074,692, filed on Nov. 4, 2014.

(51) Int. Cl. A01M 31/00

(52) U.S. Cl. CPC A01M 31/008

(57) ABSTRACT

A hunting scent releasing device is disclosed including an upper housing, a lower housing, a threaded female post attached to one of the two housings, a threaded center post attached to the other housing, and a ring-shaped seal attached to one of the housings. The seal seals an interface between the upper housing and the lower housing when the device is in a sealed state. The threaded center post is configured to be threaded into the threaded female post, wherein an amount of engagement between the threaded female post and the threaded center post place the device in either the sealed state with the housings pressed against each other or in a scent releasing state with a gap between the housings. In the sealed state, the upper housing and the lower housing sealingly enclose an interior that contains a scent material deposited upon a scent releasing wad.

### CROSS REFERENCE TO RELATED APPLICATIONS

This disclosure claims the benefit of U.S. Provisional Application No. 62/074,692, filed on Nov. 4, 2014, which is hereby incorporated by reference.

### FIELD OF THE DISCLOSURE

The present disclosure relates generally to an object for use in hunting. In particular, examples of the present disclosure are related to a device used to house and to selectably release a scent used to attract game.

### BACKGROUND

The statements in this section merely provide background information related to the present disclosure. Accordingly, such statements are not intended to constitute an admission of prior art.

Animals operate by scent. Deer and other game animals determine where other animals are and what state the other animals are in by the scent that the other animals leave in the environment. Hunters use game animal urine and other scent-emitting substances to elicit certain behaviors in game animals. In one example, a white-tail deer will approach an area marked with urine scent of another deer to the advantage of the hunter.

To elicit behaviors in animals, hunters release scent into a hunting environment. In some instances, a hunter may wish to continuously release a scent in the hunting environment over a period of time. A hunter may also wish to leave a hunting environment for a period of time to allow for certain animal behaviors to occur, and may wish to return at some later time.

### SUMMARY

A scent releasing device is disclosed which is selectably configurable in a closed or sealed state, preventing substances within the housing from escaping, or an open or scent releasing state, permitting game animals to detect the scent contained within the housing. The device includes an upper housing, a lower housing, a threaded female post attached to one of the two housings, a threaded center post attached to the other housing, and a ring-shaped seal attached to one of the housings. The seal seals an interface between the upper housing and the lower housing when the device is in the sealed state. The threaded center post is configured to be threaded into the threaded female post, wherein an amount of engagement between the threaded female post and the threaded center post place the device in either the sealed state with the housings pressed against each other or in the scent releasing state with a gap between the housings. In the sealed state, the upper housing and the lower housing sealingly enclose an interior that contains a scent material deposited upon a scent releasing wad.

### BRIEF DESCRIPTION OF THE DRAWINGS

One or more embodiments will now be described, by way of example, with reference to the accompanying drawings, in which:

FIG. 1 illustrates components of an exemplary scent releasing device with a central threaded post comprising a bolt inserted through a bottom housing of the device, in accordance with the present disclosure;

FIG. 2A illustrates the scent releasing device of FIG. 1 in cross section, with the device tightened in a sealed state, in accordance with the present disclosure;

FIG. 2B illustrates the exemplary scent releasing device of FIG. 1 in cross section, with the device opened in a scent releasing state, in accordance with the present disclosure;

FIG. 3 illustrates the exemplary scent releasing device of FIG. 1 in the sealed state, with a fixturing mechanism embodied as a wire loop affixed to a fixturing cavity formed in the device, in accordance with the present disclosure;

FIG. 4 illustrates an alternative exemplary embodiment of a scent releasing device, with a central threaded post projecting upward through an upper housing of the device, in accordance with the present disclosure;

FIG. 5 illustrates exemplary embodiment of an upper and lower housing of the device, including ribs useful for aiding a user in opening and closing the device, in accordance with the present disclosure;

FIG. 6 illustrates an exemplary embodiment of the device, including a camouflage pattern on the outside of the device, in accordance with the present disclosure;

FIG. 7 illustrates an exemplary embodiment of the device configured to look like a golf ball, in accordance with the present disclosure;

FIG. 8 illustrates an exemplary embodiment of the device configured to look like a duck, in accordance with the present disclosure;

FIG. 9 illustrates an exemplary embodiment of an upper housing of the device, including two fixturing mechanisms attached to the upper housing including an alligator clip device and a safety pin, in accordance with the present disclosure;

FIG. 10 illustrates an exemplary embodiment of an upper housing of the device, including a wire loop connected to two fixturing cavities formed in the upper housing, in accordance with the present disclosure;

FIG. 11 illustrates an exemplary scent releasing device similar to the device of FIG. 4 including an exemplary drywall wall mechanism installed to the central post, in accordance with the present disclosure;

FIG. 12 illustrates an exemplary scent releasing device wherein both a threaded male post on the top housing and a threaded female post on the lower housing are both molded into the housings, thereby reducing leak paths from the device, in accordance with the present disclosure;

FIG. 13 illustrates an exemplary scent releasing device with a cylindrically-shaped inner cavity and a pair of separable wads, in accordance with the present disclosure; and

FIG. 14 illustrates an exemplary scent releasing device with a wad sized to substantially fill an inner cavity of the device when closed, in accordance with the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale. Embodiments in accordance with the present disclosure may be embodied as an apparatus or process.

Humans, especially hunters, utilize scent-emitting substances to elicit various behaviors from animals, especially game animals. In particular, hunters may wish to lure certain animals into particular areas of a hunting environment and discourage other animals from entering such areas while hunting. Depending on the types of animals whose behavior a hunter wishes to affect, a hunter may wish to carry a scent-emitting substance on his or her person. Alternatively, a hunter may wish to temporarily leave a scent-releasing substance in a hunting environment prior to, during or after hunting.

A scent releasing device is disclosed which is selectably configurable in a closed position, preventing substances contained within an interior of the device from escaping, or an open position, permitting game animals to detect the scent contained within the housing. The scent releasing device can carry a number of affixing mechanisms which allow the device to be attached to a hunter's person, a tree, a bush, a decoy or other structure or object. The scent releasing device includes an upper housing part and a lower housing part, and a metallic threaded shaft spanning between the upper and lower housing parts. A scent releasing wad of material, for example, an absorbent pad, can be fit within the interior of the device to hold the scent material. The metallic threaded shaft can take the form of a bolt fastener, and tightening of this bolt fastener in combination with a plurality of o-ring seals and/or rubberized coatings, permits the device to be fastened tightly when not in use, preventing the animal urine or other scented substance from spilling, for example, in the pocket of the hunter. The scent releasing device can further include one or a number of affixing mechanisms on an exterior of the upper housing part, the lower housing part or both the upper housing part and the lower housing part.

According to one embodiment, the scent releasing device features ribs designed and manufactured such that a user can apply force upon the ribs to open the hunting scent housing. Hunters frequently hunt in late fall or winter months, and these ribs enable the hunter to grip the device and twist one housing in relation to the other with gloves on. According to another embodiment, the scent releasing device features ribs designed and manufactured such that the scent releasing device can remain upright on its lower housing. According to a further embodiment, the hunting scent housing carries an interference hole which receives a removable affixing mechanism.

In one embodiment, the upper and lower housing parts are designed and manufactured with camouflage pattern and colors such that the scent releasing device blends in with its surroundings in a hunting environment.

In another embodiment, the upper and lower housing parts of the scent releasing device are designed and manufactured with glow-in-the-dark material. In a further embodiment, reflective tape is secured around shafts of one or more of the affixing mechanisms. The features of these embodiments are configured to permit a hunter to easily find and retrieve the hunting scent housing devices when returning to a particular hunting environment.

In one example, the upper and lower housing parts of the scent releasing device are made of a material or combination of materials that does not allow the flow of any matter into or out of the interior of the device, such that any scent and scent-releasing substance are not able to escape from the device. In another example, the upper and lower housing parts of the scent releasing device are made of a material or combination of materials that allows for air flow between the hunting environment and the interior of the device, such that scent is released continuously into a hunting environment.

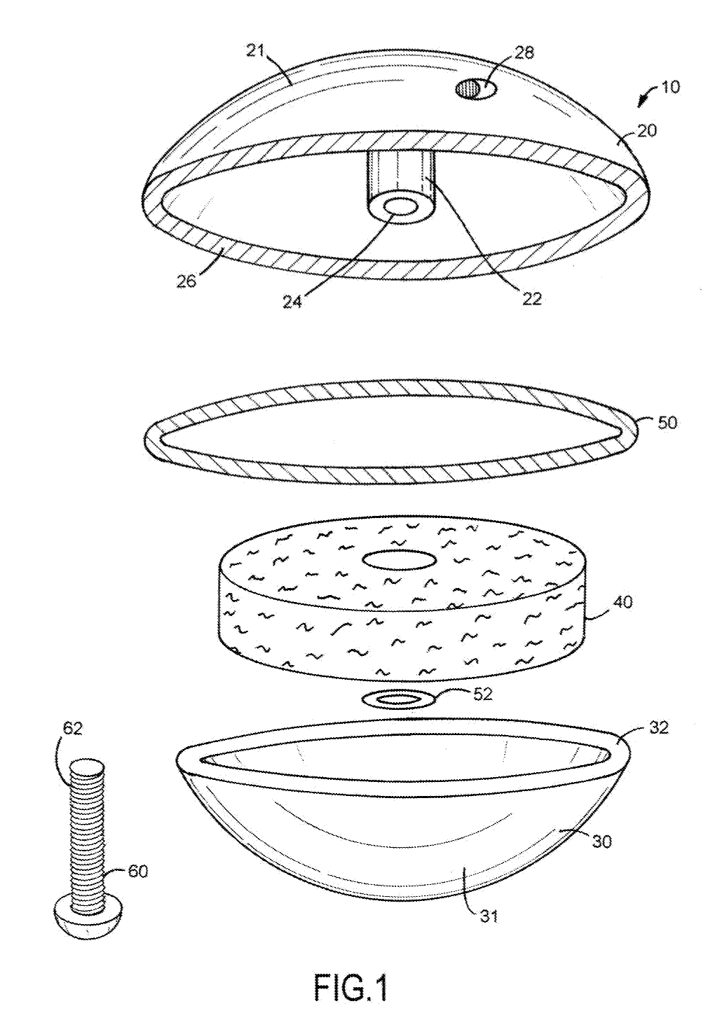

FIG. 1 illustrates components of an exemplary scent releasing device with a central threaded post comprising a bolt inserted through a bottom housing of the device. A semi-spherical upper housing 20 and a semi-spherical lower housing 30 are illustrated which are configured to be fastened together to form the scent releasing device. Center threaded post 60 is illustrated, in this non-limiting example, to include a bolt fastener. Lower housing 30 includes a hole through which post 60 can be inserted. Upper housing 20 includes threaded female post 22 including threaded section 24 configured to receive threaded end 62 of post 60. Upper housing 20 include a generally rounded outer surface 21 and a surface 26 configured to hold gasket ring 50. Upper housing 20 further includes fixturing cavity 28 configured to receive a fixturing mechanism permitting a user to attach the device to a tree, a fence, a bush, a string, or any other feature that might be present in the outdoors.

Lower housing 30 includes a generally rounded outer surface 31 and sealing surface 32 configured to seal against gasket ring 50 as the upper housing is tightened against the lower housing.

Fibrous wad 40 is illustrated including a cylindrical absorbent pad that can be soaked with the scent material. Fibrous wad 40 can include any of a number of materials known in the art, such as cotton, felt, or synthetic fiber materials. Wad 40 includes a central hole for post 60 to be installed therethrough.

A small gasket 52 is configured to fit tightly around central post 60 can be used to seal a connection point between post 60 and the bottom hole of the lower housing to prevent the scent material from leaking out of the device. A small gasket an additionally or alternatively be used on post 60 a small distance off of the bottom of the housing to elevate wad 40 within the device and promote greater release of the scent by permitting air to get underneath wad 40.

Upper housing 20 and lower housing 30 can be made of any suitable and resilient polymer material, such as acrylonitrile butadiene styrene (ABS), polypropylene, or polyethylene. The housings can be made through injection molding, blow molding, vacuum molding, or any other manufacturing method known in the art and suitable for a particular configuration of the part.

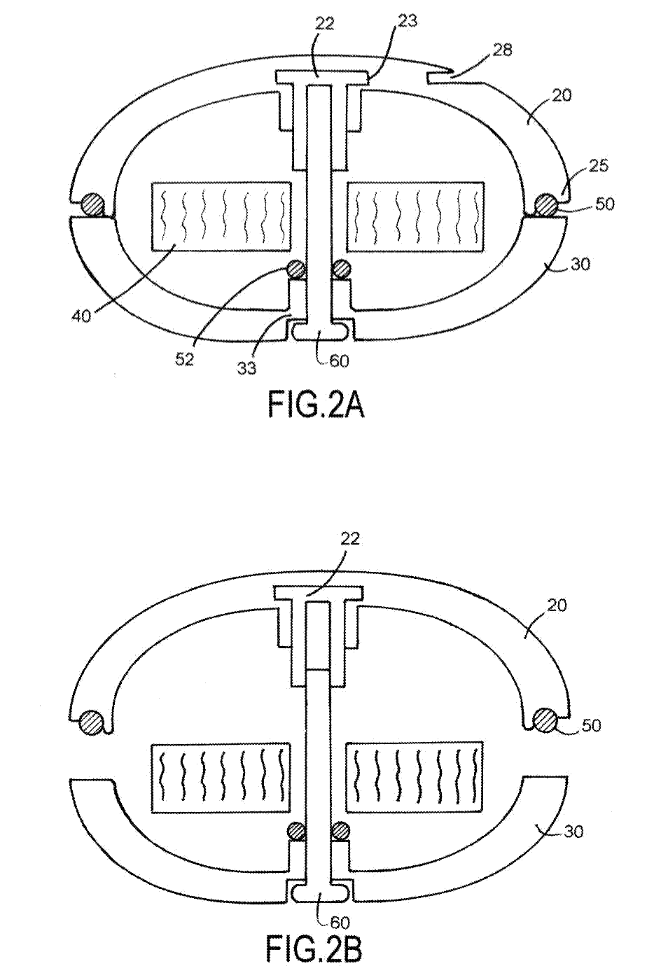

FIG. 2A illustrates the scent releasing device of FIG. 1 in cross section, with the device tightened in a sealed state. Upper housing 20 is illustrated including threaded female post 22 molded within the upper housing, such that post 22 cannot rotate with respect to housing 20. Upper housing 20 can include thickened features 23 to reinforce the connection between the upper housing 20 and post 22. Upper housing 20 further includes fixturing cavity 28 which in some embodiment can be formed to not penetrate the inside of the device, thereby avoiding a potential leak path for the scent material to escape the device. Upper housing 20 further includes tongue and groove feature 25 configured to accept and hold in place gasket ring 50 against the upper housing.

Lower housing 30 includes hole feature 33 permitting post 60 to be inserted within and through feature 33, such that the post extends upwardly from the lower housing 30 to be threaded into and hold fixingly the upper housing 20 and post 22. Wad 40 is illustrated contained within the upper housing 20 and lower housing 30. Gasket 52 is illustrated sealing a connection point between post 60 and feature 33, such that leakage out of the lower housing at the connection between post 60 and lower housing 30 is reduced or eliminated.

FIG. 2B illustrates the exemplary scent releasing device of FIG. 1 in cross section, with the device opened in a scent releasing state. Upper housing 20 can be rotated in relation to lower housing 30, such that post 60 partially unscrews from post 22. As a result, the housings 20 and 30 are separated, gasket 50 no longer seals against the lower housing 30, and air can pass between the housings and pick up scent from the suspended wad.

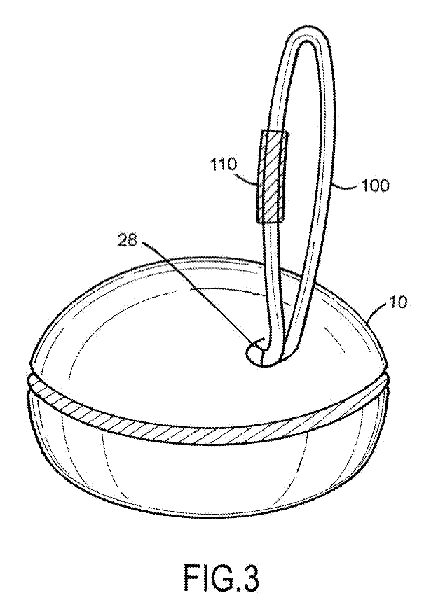

FIG. 3 illustrates the exemplary scent releasing device of FIG. 1 in the sealed state, with a fixturing mechanism embodied as a wire loop affixed to a fixturing cavity formed in the device. Scent device 10 is illustrated including wire loop 100 inserted within fixturing cavity 28 of device 10. Loop 100 can be easily connected to a tree branch or a wire on a fence. Reflective tape 110 is illustrated optionally attached to wire loop 100, such that a hunter wishing to retrieve the device can shine a flashlight and quickly locate the device from a distance. It will be appreciated that the housings could be reversed, and the properties of the lower housing 30 and post 60 could be embodied on a top half of the device, and the properties of the upper housing 20 and post 22 could be embodied on a lower half of the device.

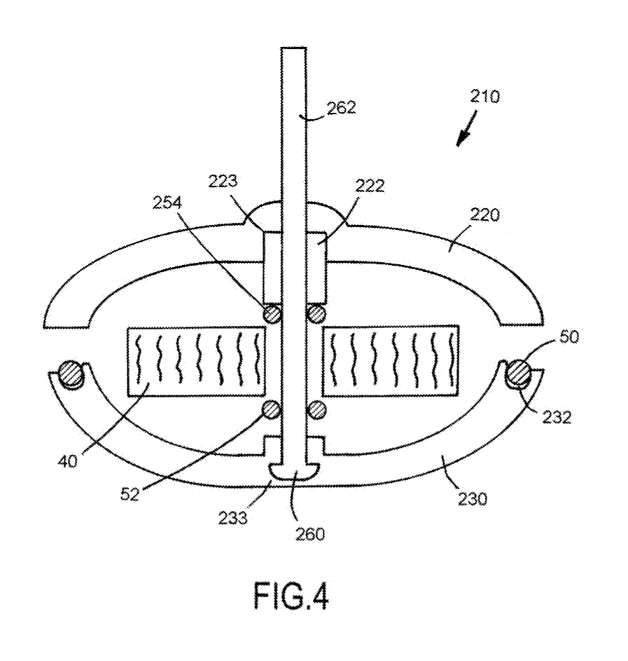

FIG. 4 illustrates in cross section an alternative exemplary embodiment of a scent releasing device, with a central threaded post projecting upward through an upper housing of the device. A semi-spherical upper housing 220 and a semi-spherical lower housing 230 are illustrated which are configured to be fastened together to form the scent releasing device. Center threaded post 260 is illustrated, in this non-limiting example, molded within lower housing 230 such that the post 260 cannot rotate relative to the lower housing 230. Upper housing 220 includes threaded female post 222 including threaded section configured to receive threaded end 262 of post 260 and permit the threaded end to extend upwardly through the upper housing. The exposed portion of post 260 can be used to attach fixturing mechanisms to the device. Upper housing 220 include a generally rounded outer surface and a flat surface around the perimeter of the connection with the lower housing to seal against gasket ring 50.

Lower housing 230 includes a generally rounded outer surface and grooved surface 232 configured grip to and hold in place gasket ring 50 around the perimeter of the lower housing 230.

Fibrous wad 40 is illustrated including a cylindrical absorbent pad that can be soaked with the scent material. A small gasket 52 is configured to fit tightly around central post 260 and is illustrated fitted to post 60 a small distance off of the bottom of the housing to elevate wad 40 within the device and promote greater release of the scent by permitting air to get underneath wad 40.

FIG. 5 illustrates exemplary embodiment of an upper and lower housing of the device, including ribs useful for aiding a user in opening and closing the device. Upper housing 320 is illustrated including two ribs 322 configured to aid in rotating the upper housing 320 in relation to lower housing 330. Lower housing 330 is illustrated including a plurality of ribs 332 configured to aid the user in rotating the housings. A lower surface 334 of ribs 332 can be configured to be flat, such that the device can be placed in a stable condition on a table, a flat fence post, or any other surface upon which the user may need to adjust or fill the device.

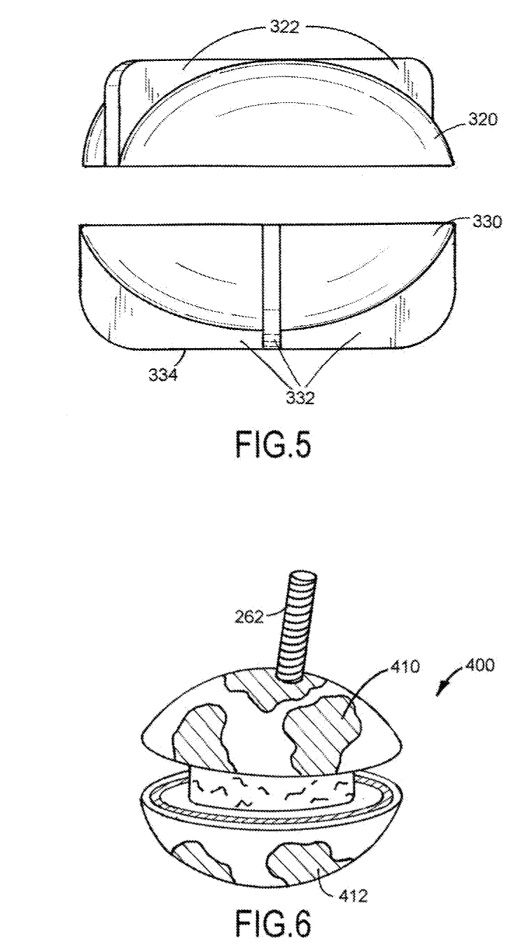

FIG. 6 illustrates an exemplary embodiment of the device, including a camouflage pattern on the outside of the device. Device 400 is illustrated including an upper housing with a camouflage pattern 410 printed thereupon and a lower housing with a camouflage pattern 412 printed thereupon. Post 262 is illustrated extending from a top of device 400. Post 262 is illustrated canted with respect to lower housing. In one embodiment, post 262 can be permitted to pivot with respect to lower housing, thereby allowing the user to tilt the upper housing with respect to the lower housing, thereby making it easier to put the scent material within the device or to adjust the wad position within the device.

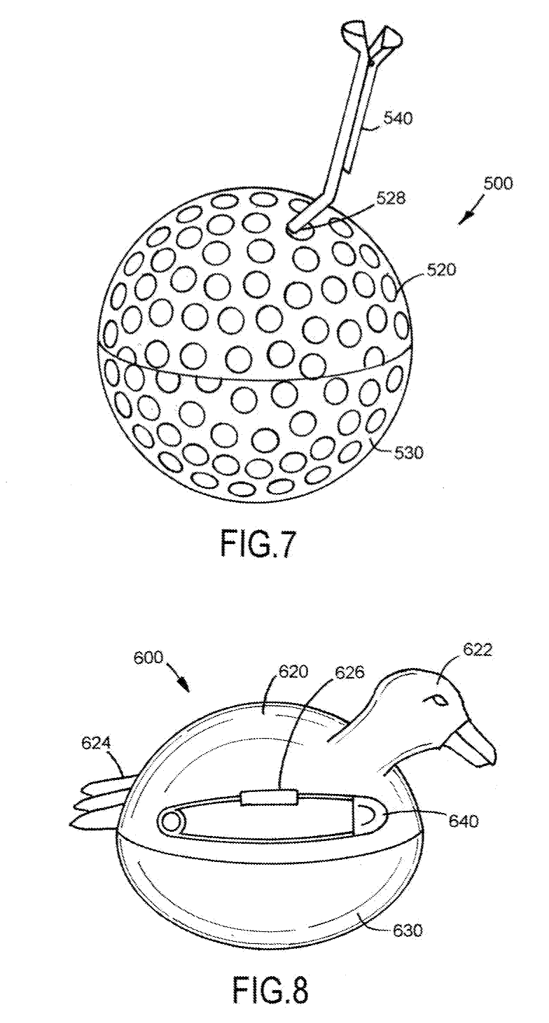

FIG. 7 illustrates an exemplary embodiment of the device configured to look like a golf ball. Scent releasing device 500 is illustrated to be marketed to the sports enthusiast hunter. Upper housing 520 and lower housing 530 are dimpled and combine to form around facsimile of a golf ball. An exemplary fixturing mechanism 540 comprising a spring loaded pin is inserted within fixturing cavity 528 of upper housing 520 and is generally configured to look like a golf tee. A number of different sporting balls can be approximated, including a baseball, a basketball, a bowling ball, and a billiard ball, and the disclosure is not intended to be limited to the particular examples provided herein.

FIG. 8 illustrates an exemplary embodiment of the device configured to look like a duck. Scent releasing device 600 is illustrated in the shape of a duck to be generally marketed for appearance. Upper housing 620 includes duck head shape 622 and duck tail shape 624. A fixturing mechanism 640 in this instance provided as a safety pin is inserted through a fixturing bracket 626 formed upon upper housing 620. Upper housing 620 and lower housing 630 can be molded in a white or yellow plastic or painted with a similar color or a pattern imitating a mallard duck depending upon what is needed for the marketplace.

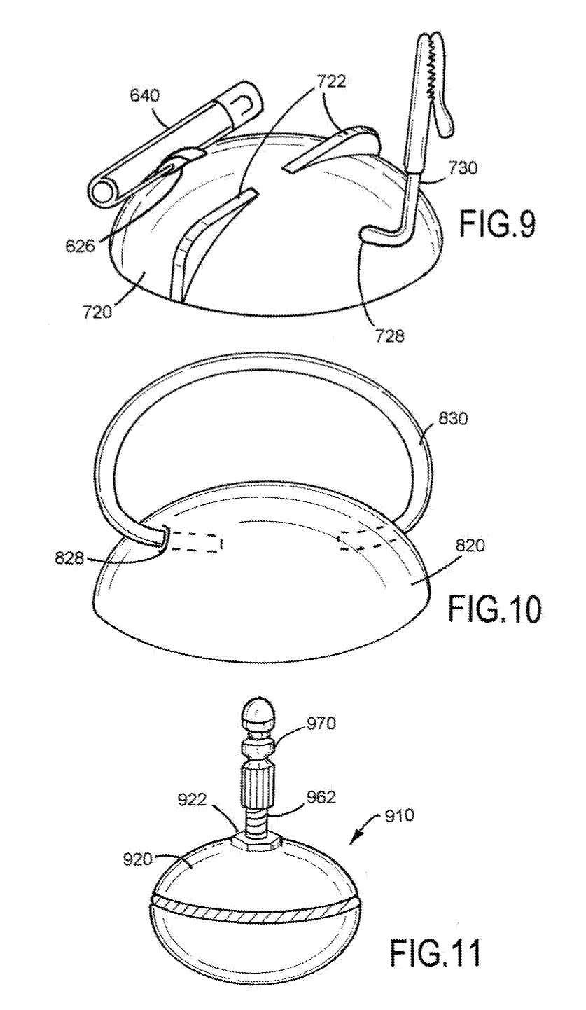

FIG. 9 illustrates an exemplary embodiment of an upper housing of the device, including two fixturing mechanisms attached to the upper housing including an alligator clip device and a safety pin. A first fixturing mechanism 730 including an alligator clip device and a second fixturing mechanism 640 including a safety pin are illustrated. Mechanism 730 includes a wire section that is inserted within fixturing cavity 728 of upper housing 720. Mechanism 640 is illustrated inserted through fixturing bracket 626 formed upon upper housing 720. Two ribs 722 are illustrated formed upon upper housing 720.

FIG. 10 illustrates an exemplary embodiment of an upper housing of the device, including a wire loop connected to two fixturing cavities formed upon the upper housing. Upper housing 820 is illustrated including two fixturing cavities 828 receiving wire ends of wire loop 830. Loop 830 can be used to suspend the device upon any of a number of objects. One or both ends of loop 830 can be easily removed from its respective cavity 828 and replaced to either attach or remove the device from an object for use.

FIG. 11 illustrates a scent releasing device similar to the device of FIG. 4 including an exemplary drywall attachment mechanism installed to the central post. Device 910 is illustrated in a closed state. An end portion 962 of a threaded central post is illustrated projecting from a top of the device. Threaded female post 922 is illustrated as a hexagonally shaped feature that fits into a matching shape upon upper housing 920. In this way, post 922 need not be molded into the upper housing 920. A drywall attachment mechanism 970 commonly used to secure a threaded fastener within a section of drywall is illustrated installed to portion 962. A user can drill or find a hole or crevice within which the mechanism 970 can be inserted in order to fixture the device while in use.

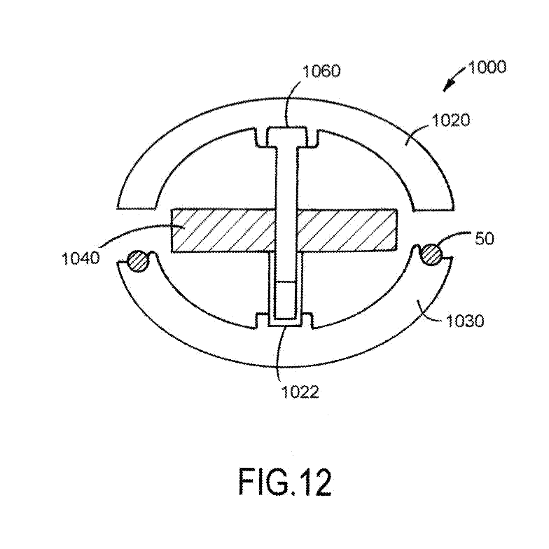

FIG. 12 illustrates an exemplary scent releasing device wherein both a threaded male post on the top housing and a threaded female post on the lower housing are both molded into the housings, thereby reducing leak paths from the device. Device 1000 is illustrated including upper housing 1020 and lower housing 1030. Gasket ring feature 50 is illustrated installed to lower housing 1030. Threaded female post 1022 is illustrated molded into lower housing 1030, and threaded central post 1060 is illustrated molded into upper housing 1020. By molding both posts 1022 and 1060 into the lower housing 1030 and upper housing 1020, respectively, a leak path for the scent material to escape the device in a closed position, through holes made for a bolt or post to extend through the housings, is eliminated. Further, wad 1040 is illustrated constructed of a dense or stiffened material, such that the wad 1040 can be suspended over post 1022 without the aid of an o-ring gasket.

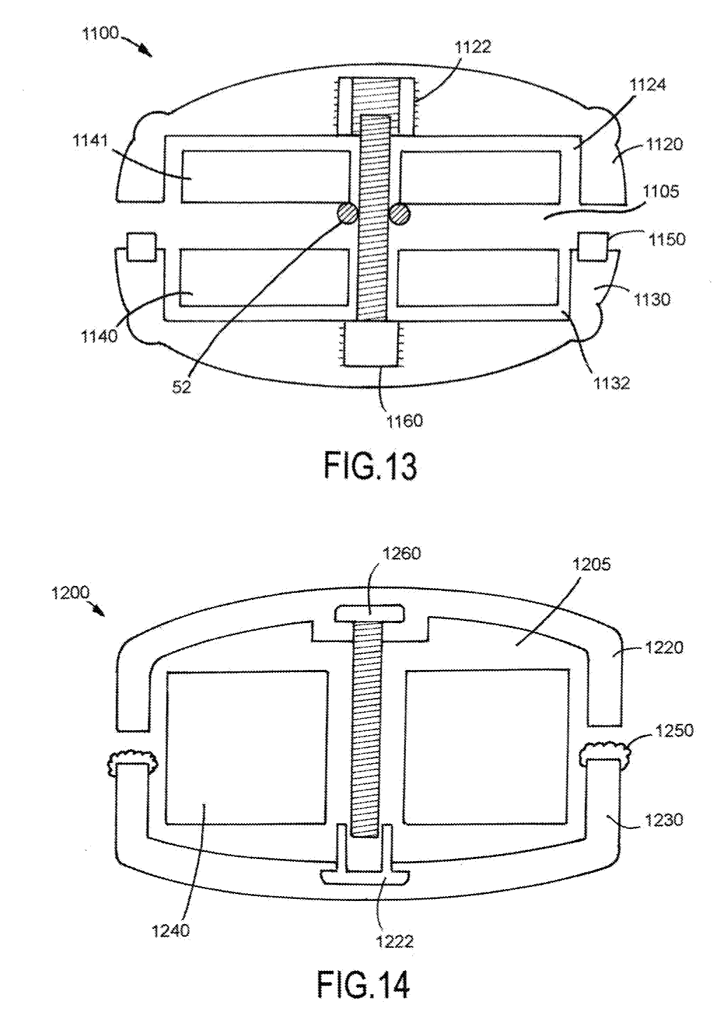

FIG. 13 illustrates an exemplary scent releasing device with a cylindrically-shaped inner cavity and a pair of separable wads. Device 1100 is illustrated including upper housing 1120 and lower housing 1130. Gasket ring feature 1150 is illustrated, including an exemplary square cross section, installed to lower housing 1130. Threaded female post 1122 is illustrated threaded or screwed into housing 1120, and threaded central post 1160 is illustrated threaded or screwed into lower housing 1130. Inner cavity 1105 is illustrated including straight vertical sidewalls 1124 and 1132 to substantially match the profile of wads 1140 and 1141. Wads 1140 and 1141 can be used together to increase an overall surface area of the wads providing the scent material to the air. Gasket 52 is illustrated installed to central post 1160 to elevate wad 1141 off of wad 1140. Adhesive can alternatively or additionally be used to fasten both post 1160 and post 1122 into the respective housings.

FIG. 14 illustrates an exemplary scent releasing device with a wad sized to substantially fill an inner cavity of the device when closed. Device 1200 is illustrated including upper housing 1220 and lower housing 1230. Polymerized coating 1250 is illustrated applied to lower housing 1230. Coating 1250 can be many different substances, for example, with a soft rubberized polymer being applied to the housing in a two shot molding process known in the art being one exemplary embodiment for the coating. Threaded female post 1222 is illustrated molded into housing 1230, and threaded central post 1260 is illustrated molded into upper housing 1220. Inner cavity 1205 is illustrated including straight vertical sidewalls and to substantially match the profile of wad 1240. Wad 1240 is selected to substantially fill cavity 1205 when the device is closed.

Scent-releasing substances may be liquids, gels or solids, or may exist in other forms. In one embodiment, the gasket is plastic. In another embodiment, the gasket is metal. In a further embodiment, the gasket is rubber. Different gasket materials or combinations of materials may more effectively contain particular types of scents or scent-releasing substances.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

What is claimed is:

1. A hunting scent releasing device comprising:
an upper housing;
a lower housing;
a threaded female post attached to a first of the two housings;
a threaded center post attached to a second of the two housings and configured to be threaded into the threaded female post, wherein an amount of engagement between the threaded female post and the threaded center post place the device in either a sealed state with the housings pressed against each other or in a scent releasing state with a gap between the housings;
a ring-shaped seal attached to one of the upper housing and the lower housing, the seal sealing an interface between the upper housing and the lower housing when the device is in the sealed state; and
wherein, in the sealed state, the upper housing and the lower housing sealingly enclose an interior that contains a scent material deposited upon a scent releasing wad.

2. The device of claim 1, wherein the upper housing is a semi-spherical upper housing; and
wherein the lower housing is a semi-spherical lower housing;

3. The device of claim 1, wherein the interior includes straight vertical side walls.

4. The device of claim 1, wherein the upper housing includes a fixturing cavity open to an outside of the device for affixing a fixturing mechanism to the device, wherein the fixturing cavity does not penetrate to the interior of the device.

5. The device of claim 1, further comprising an o-ring seal installed to the central post.

6. The device of claim 5, wherein the o-ring seal is located at a location where the central post meets one of the housings.

7. The device of claim 5, wherein the o-ring seal is located at a location beneath and supporting the scent releasing wad.

8. The device of claim 5, wherein the o-ring seal is located at a location where the female post meets one of the housings.

9. The device of claim 1, further comprising a second scent releasing wad.

10. The device of claim 1, wherein the central post and the female post are connected to the interior of the device and do not penetrate an outside surface of the device.

11. The device of claim 1, wherein the central post extends through the upper housing.

12. The device of claim 11, further comprising a fixturing mechanism attached to a portion of the central post extending through the upper housing.

13. The device of claim 1, further comprising a safety pin connected to the device for affixing the device during use.

14. The device of claim 1, further comprising an alligator clip mechanism connected to the device for affixing the device during use.

15. The device of claim 1, further comprising a wire loop connected to the device for affixing the device during use.

16. The device of claim 1, further comprising a reflective connected to the device.

17. The device of claim 1, wherein the ring-shaped seal comprises an o-ring seal configured to be situated in a groove in one of the housings around a perimeter of the interface.

18. The device of claim 1, wherein the ring shaped seal comprises a rubberized ring with a square cross-section.

19. The device of claim 1, wherein the ring shaped seal comprises a polymerized coating applied to one of the housings.
